(19) United States
(12) Patent Application Publication
(10) Pub. No.: US 2025/0249432 A1
(43) Pub. Date: Aug. 7, 2025

(54) SUPER ABSORBENT UTILITY PAD AND METHODS OF USING SAME

(71) Applicant: Geerpres, Inc., Norton Shores, MI (US)

(72) Inventors: Scott E. Ribbe, Spring Lake, MI (US); James A. Mitchell, Grand Rapids, MI (US)

(73) Assignee: Scott E. Ribbe, Spring Lake, MI (US)

(21) Appl. No.: 19/043,312

(22) Filed: Jan. 31, 2025

Related U.S. Application Data
(60) Provisional application No. 63/549,269, filed on Feb. 2, 2024.

(51) Int. Cl. B01J 20/28; B01J 20/26; B32B 3/02; B32B 5/02; B32B 5/06; B32B 5/26; B32B 7/04

(52) U.S. Cl. CPC B01J 20/2805; B01J 20/26; B32B 3/02; B32B 5/02; B32B 5/022; B32B 5/073; B32B 5/265; B32B 7/04; B32B 2250/20; B32B 2250/40; B32B 2250/44; B32B 2307/726; B32B 2432/00

(57) ABSTRACT

A relatively thin utility pad impregnated with super absorbent polymer (SAP) particles and the use of the utility pads to absorb and control water and water based liquids in waste receptacles or in floods or spills or as a mop pad, bed liner, adult diaper, etc. The thin utility pad has four layers: a water permeable fabric top layer, a water permeable fabric bottom layer, and two layers of non-woven fleece sandwiched between said top and bottom water permeable fabric layers. The intermediate fleece layers hold between them finely divided crystalline particles of super absorbent polymer, preferably evenly distributed through the space between the layers. The edges of at least the top and bottom fabric layers are secured together as such that the SAP particles cannot escape from between the fleece layers.

### CROSS-REFERENCE TO RELATED APPLICATIONS

This application claims the benefit of U.S. App. No. 63/549,269 filed Feb. 2, 2024, titled Super Absorbent Utility Pad And Methods Of Using Same.

### BACKGROUND

A superabsorbent polymer (SAP) (also called slush powder) is a water-absorbing hydrophilic homopolymers or copolymers that can absorb and retain extremely large amounts of water or water based liquids relative to its own mass. Water-absorbing polymers, which are classified as hydrogels when mixed, absorb aqueous solutions through hydrogen bonding with water molecules. An SAP's ability to absorb water depends on the ionic concentration of the aqueous solution. In deionized and distilled water, a SAP may absorb 300 times its weight [4] (from 30 to 60 times its own volume) and can become up to 99.9% liquid. When put into a 0.9% saline solution the absorbency drops to approximately 50 times its weight. The presence of valence cations in the solution impedes the polymer's ability to bond with the water molecule.

The SAP's total absorbency and swelling capacity are controlled by the type and degree of cross-linkers used to make the gel. Low-density cross-linked SAPs generally have a higher absorbent capacity and swell to a larger degree. These types of SAPs also have a softer and stickier gel formation. High cross-link density polymers exhibit lower absorbent capacity and swell, and the gel strength is firmer and can maintain particle shape even under modest pressure.

Superabsorbent polymers are crosslinked in order to avoid dissolution. There are three main classes of SAPs:
1. Cross-linked polyacrylates and polyacrylamides
2. Cellulose- or starch-acrylonitrile graft copolymers
3. Cross-linked maleic anhydride copolymers^{[1]}

The largest use of SAPs is found in personal disposable hygiene products, such as baby diapers, adult diapers and sanitary napkins.^{[5]} SAPs were discontinued from use in tampons due to 1980s concern over a link with toxic shock syndrome. SAPs are also used for blocking water penetration in underground power or communications cable, in self-healing concrete, horticultural water retention agents, control of spill and waste aqueous fluid, and artificial snow for motion picture and stage production. The first commercial use was in 1978 for use in feminine napkins in Japan and disposable bed liners for nursing home patients in the USA.

### SUMMARY OF THE INVENTION

The present invention comprises a relatively thin utility pad impregnated with super absorbent polymer (SAP) particles and the use of the utility pads to absorb and control water and water based liquids in waste receptacles or in floods or spills. This makes handling the receptacles and facilitating waste disposal from the waste receptacles more convenient and less sloppy. Distributing the pads on flooded or spilled-on floors and then retrieving them greatly reduces the time needed to manage such messes. The term “liquids” includes water and water based products such as alcoholic and non-alcoholic beverages, soda pops, beer, juices, etc.

The thin utility pad in one embodiment comprises four layers: a water permeable fabric top layer, a water permeable fabric bottom layer, and two layers of non-woven fleece sandwiched between said top and bottom water permeable fabric layers. The intermediate fleece layers hold between them finely divided crystalline particles of super absorbent polymer, preferably evenly distributed through the space between the layers. The edges of at least the top and bottom fabric layers are secured together as such that the SAP particles cannot escape from between the fleece layers.

The super absorbent pad can also be used as a mop pad, bed liner, adult diaper, etc., depending on specific construction.

These and other features, objects and advantages of the invention will be more fully appreciated by reference to the written description and appended drawings below.

### BRIEF DESCRIPTION OF THE DRAWINGS

FIG. 1 is an elevational view of the thin dry utility pad 10, ready for use;

FIG. 2 is a perspective view of the dry utility pad 10 with one portion cut away to facilitate identification of the four layers comprising pad 10;

FIG. 3 is a plan view of a segment of fleece layers 13 and 14 partially separated and partially folded over to expose napped surfaces 13b and 14b on each;

FIG. 4 is a close up of a fleece layer with some SAP particles 20;

FIG. 5 is a plan view of a napped side 13b/14b of a fleece layer 13 or 14, dusted with pepper particles which serve as visible representatives for the SAP particles scattered through the nap fibers NF on the nap surface 13b or 14b of the fleece;

FIG. 6 is a perspective view of pad 10 after it has absorbed water in the test of the first embodiment pad 10 set forth below;

FIG. 7 is an elevational view of the second embodiment pad 100;

FIGS. 8A and 8B are partially perspective cross-sectional views of the four-layer utility pad 100 of the second embodiment;

FIG. 9 is a plan view of a portion of the second embodiment bottom woven layer 120, with the intermediate layer 140 above it peeled away from it, showing the appearance of the dimples in the normally covered surface of the bottom woven layer 120;

FIG. 10 is a magnified plan view of one of the dimpled intermediate layers with finely divided super absorbent polymer crystals distributed on its surface; and

FIG. 11 is a view showing the utility pad as swollen with absorbed, controlled liquid.

### DETAILED DESCRIPTION

### First Preferred Embodiment

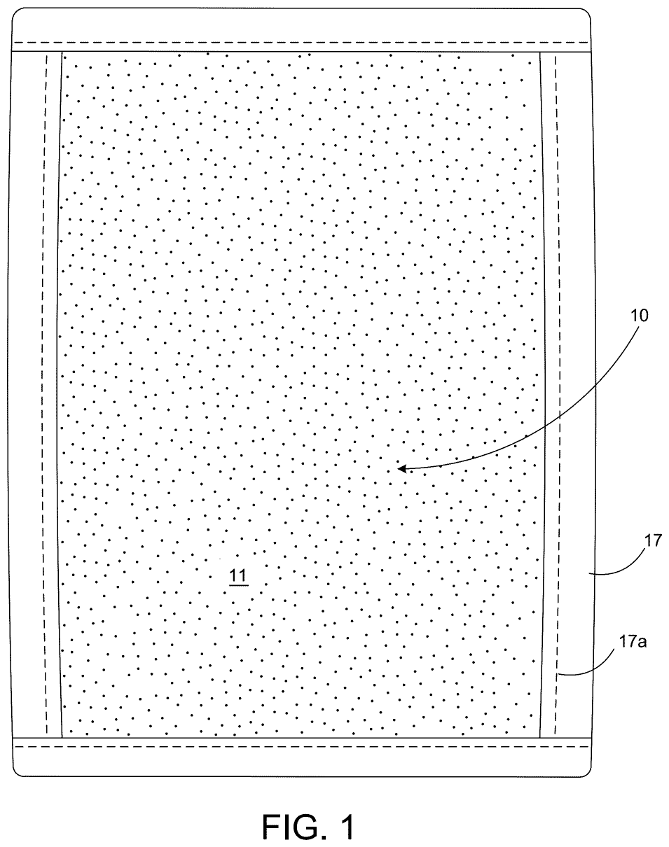

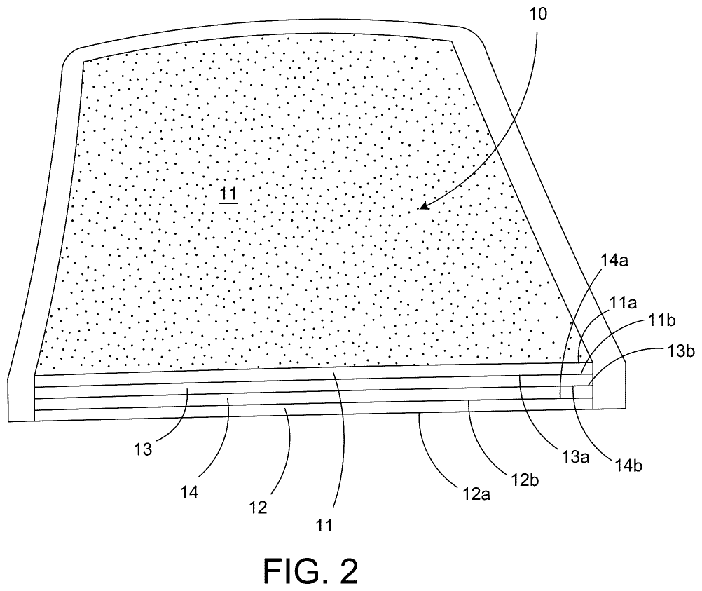

The utility pad 10 of the first preferred embodiment is about one square foot large and comprises four layers: a water permeable fabric top layer 11, a water permeable fabric bottom layer 12, and two intermediate layers of non-woven fleece 13 and 14 sandwiched between said top and bottom water permeable fabric layers 11 and 12. The two fleece layers have a plurality of preferably evenly distributed SAP particles 20 sandwiched between them. The top and bottom layers 11 and 12 are identical, and they are labeled “top” and “bottom” here only because of their orientation as pictured in FIG. 2. (FIGS. 1 &2) Each top and bottom layer 11 and 12 layer is a thin sheet of woven microfiber. Non-woven could be used, but woven adds strength and integrity, which further minimizes a tear in layer 11 or 12 which might result in the escape of some SAP particles 20.

It is important that layers 11 and 12 be water permeable so that waste liquids in a waste container or spilled on a floor can penetrate layers 11 and 12 into the fleece layers 13 and 14 and be absorbed by the SAP particles 20. To that end, hydrophilic fibers should be used to fabricate layers 11 and 12. Hydrophilic fibers can be natural and synthetic. Examples of natural hydrophilic fibers include cotton, linen, and wool. Examples of synthetic hydrophilic fibers include polyester, polyamides, nylon and rayon. The preferred embodiment fiber is a blend of viscose and polyester, most preferably at 30% viscose and 70% polyester. However, even fibers which are not naturally hydrophilic, such as polypropylenes, can be made hydrophilic by certain post processing steps during production.

In FIG. 1, only one side of utility pad 10 is shown, and since layers 11 and 12 are the same, the layer shown in FIG. 1 is identified as layer 11, but could be layer 11 or 12. Layers 11 and 12 each have an exterior surface 11a and 12a which face outwardly as used, and interior surfaces 11b and 12b which face inwardly in use toward their adjacent fleece relatively smooth face 13a and 14a respectively. Layers 11 and 12 are secured together near the perimeters of their interior surfaces 11b and 12b by sewn seam 17a, adhesion or sonic welding to define a border 17 at the perimeter of utility pad 10. The use of a sewn seam is preferred, in that it will leave the edges of layers 11 and 12 exposed. This will leave water free to wick through the exposed edges past the sewn seam, and into the fleece layers 13 and 14. If those edges were sealed together by adhesion or sonic welding, such wicking would not as easily occur.

Preferably the intermediate fleece layers 13 and 14 are just smaller enough at their perimeters that no portion of their fleece bearing perimeters are caught beyond the sewn line 17a, or otherwise within the secured together inwardly facing edge portions of top and bottom layers 11 and 12. This insures that no SAP particles 20 will be trapped within the border 17 outside the seam forming the border and leak out of border 17 and become and cause an inconvenience in storing and handling the utility pads.

In an alternative embodiment, the top layer 11 and bottom layer 12 edges of utility pad 10 are sewn or sealed together along their exterior facing edge portions. When the layers 11 and 12 are folded over such that their interior surfaces face each other, the edges of pad are sealed at their edges by the fold over hem 17 formed between top layer 11 and bottom layer 12 of utility pad 10 which prevents SAP particles 20 from escaping pad 10. This alternative fold-over hem however prevents desired wicking from the exposed edge portions of layers 11 and 12 when those layers are secured together with a sewn line 17a through their facing interior surfaces 11b and 12b.

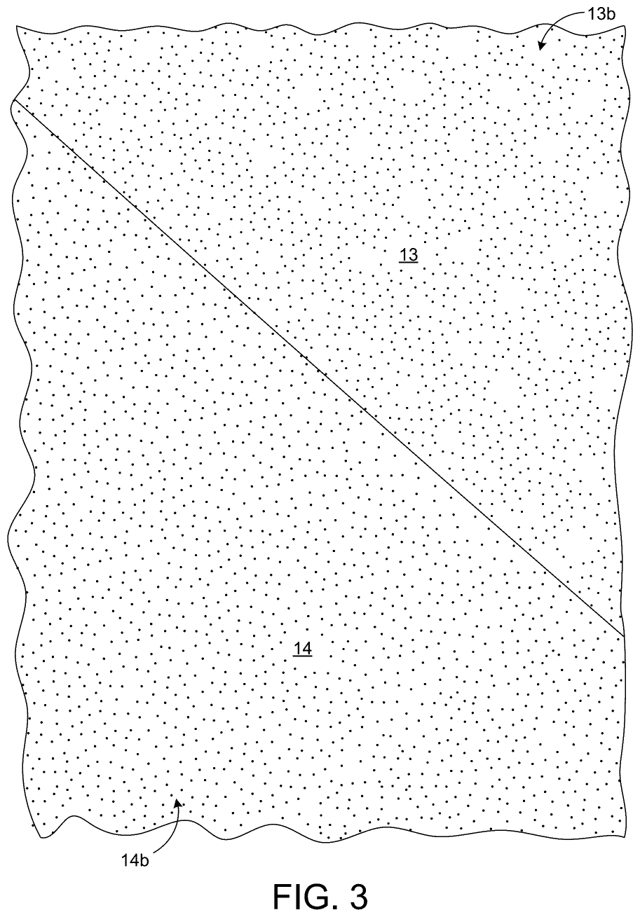

As can be seen in FIGS. 2 and 3, each of the intermediate fleece layers 13 and 14 have a relatively smooth surface 13a and 14a, respectively, and an opposite side lightly napped surface 13b and 14b, respectively. The fleece surfaces 13b and 14b are preferably lightly napped in that the raised nap surface of each comprises a plurality of short nap fibers NF projecting away from their napped surfaces. The napped surfaces 13b and 14b of the two fleeces face each other such that the short fleece fibers project toward each other between the two fleece layers. The intermediate fleece layers hold between their facing napped surfaces 13b and 14b finely divided crystalline particles of super absorbent polymer 20, preferably evenly distributed through the space between the layers. Preferably, one of both of the facing fleece layers 13b or 14b are treated with a light spray of adhesive; or preferably, fleece layers 13 and 14 are subjected to light ultrasonic treatment when put together with napped surfaces 13b and 14b facing each other. The facing napped fibers become adhered to or entangled with their facing counterparts, and the facing layers 13 and 14 stay lightly adhered to one another.

Before bringing facing fleece layers 13 and 14 together, the napped side 13b/14b of one or both layers are sprayed with SAP particles in a stream of hot air blown into the passing fleece which is then pressed and cut into appropriate thickness intermediate layers. The spraying is conducted such that about 1 to about 4 grams of SAP particles per square inch of fleece is deposited on its napped side 13b/14b, preferably about 1.7 grams per square inch. Also, the spraying is conducted such that the SAP particles are evenly distributed over the area of the napped fiber surface. When the facing layers are then brought together, the inwardly facing entangled nap fibers NF help to maintain the finely divided crystalline particles of super absorbent polymer in the positions where they were initially distributed. This prevents the particles from concentrating at the sides or other locations in the space between the two fleece layers.

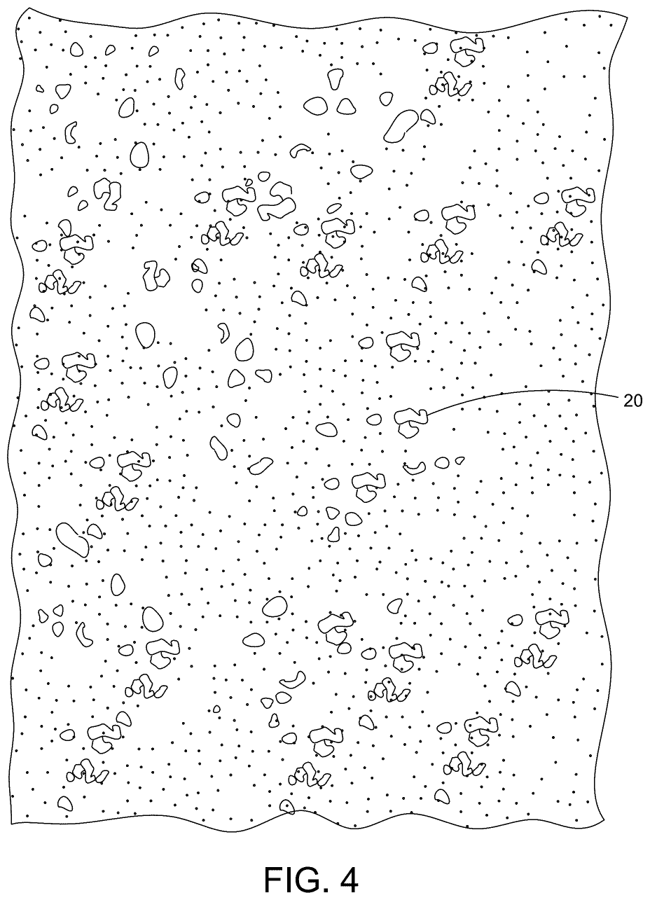

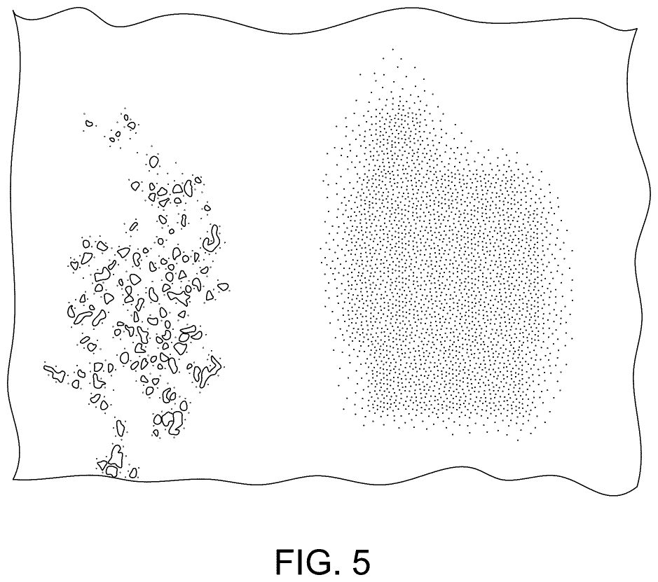

Because the fleece layers 13 and 14 are white, and the SAP particles 20 are white, it is somewhat difficult to show the relationship between the nap fibers NF and the SAP particles 20. However, because the adherence between layers 13 and 14 is light, they can be gently separated from one another or partially separated as shown in FIG. 3. FIG. 4 shows a close up of a portion of the nap side 13b or 14b of one of the fleece layers 13 or 14, with some of the nap fibers NF and some SAP particles 20. FIG. 5 is helpful in this regard because clearly visible pepper particles, representing SAP particles 20, have been shaken into the napped side 13b/14b of a fleece layer 13 or 14. The nap fibers NF help maintain the particles in place, especially when the two nap surface 13b and 14b are assembled lightly adhered together facing each other.

Finely divided crystals of super absorbent polymer 20 are preferably used since that increases their effective surface area for reacting with and absorbing water. A good range of particle size is. 1 mm to 0.3 mm . . . 2 mm is preferred.

At the preferred dimension of one square foot and at 1-4 grams SAP particles per square inch, the inner fleeces 13 and 14 carry from about 144 to about 576 grams of SAP particles equally distributed between them. At the preferred rate of 1.7 grams per square inch, the amount is about 245 grams. Most of that will be located between the facing napped surfaces 13b and 14b, but some small amount of SAP particles will be within one or the other fleece layers and some small amount will be on the outside of the fleece layers.

It is preferred that Super Absorbent Utility Pad 10 be relatively thin both for packaging and shipping purposes, and for handling when they are being distributed to multiple waste cans, for example at a sporting event. An overall thickness of 0.1 to 0.25 inches is preferred. In the more preferred embodiment, both top and bottom woven layers 11 and 12 are each relatively thin, each having an at rest thickness of about 0.5 mm. Each of the fleece layers 13 and 14 have a thickness of about 1.5 mm. This gives utility pad 10 an overall thickness of about 4 mm, which is about 0.16 inches.

In this first preferred embodiment, the top and bottom layers 11 and 12 are not adhered to the intermediate layers. Further, the inner layers 13 and 14 are only lightly adhered to one another. This is important because when the SAP particles start to absorb, we do not want the layers to be so firmly adhered to one another that they restrict the extent to which Pad 10 can swell. That consideration also affects the decision on how large pad 10 should be. A 12×12-inch pad 50 will expand into a greater volume than a 6×6-inch pad will. Of course, one also has to consider the amount of SAP particles used in pads 10 of varied sizes.

### Test Results for First Preferred Embodiment

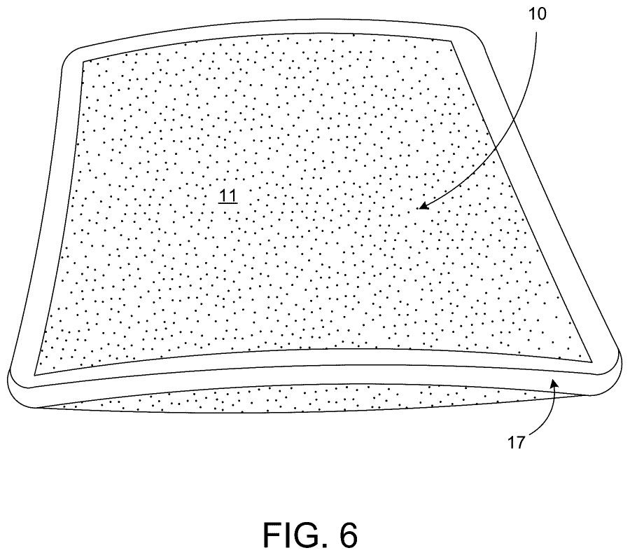

For testing, we placed a dry pad 10 in a 14×14-inch pan with an average depth of about 2 inches. We added tap water in 16 oz amounts at a time, and when it was all soaked up, we added another 16 oz. Preferred embodiment Pad 10 absorbed one gallon of water in one minute, and 3 gallons thereafter in about 6 minutes. Pad 10 had swollen to a height of about 3 inches. The water swollen duty pad 10 is shown laid on a floor in FIG. 6.

### Second Preferred Embodiment

The primary distinguishing feature of second embodiment super absorbent pad 100 from first embodiment pad 10 is its use of dimples 160 and layer adherence to restrict movement of SAP particles 20 in their originally dispersed positions below the top and bottom layers 110 and 120. Also, the second embodiment the border 170 of pad 100 is a ribbon 170 over the edges of over the edges of top and bottom layers 110 and 120 to seal SAP particles between layers 110 and 120. To the extent the various components of the second embodiment are similar to corresponding components in the first embodiment, they will be similarly numbered, but with a 0 added to the number. Thus, the second embodiment super absorbent pad is pad 100 instead of pad 10. The SAP particles 20 are the same composition in both embodiments and thus are always “particles 20.”

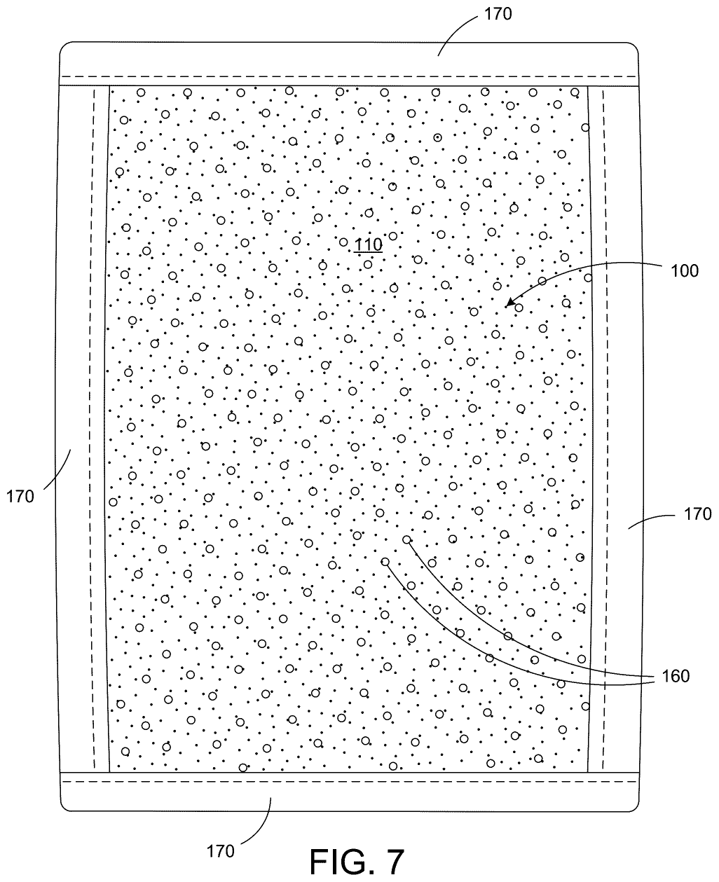

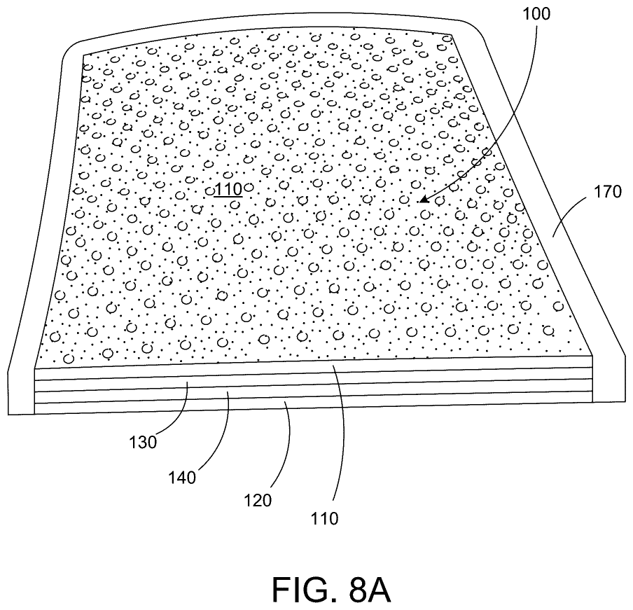

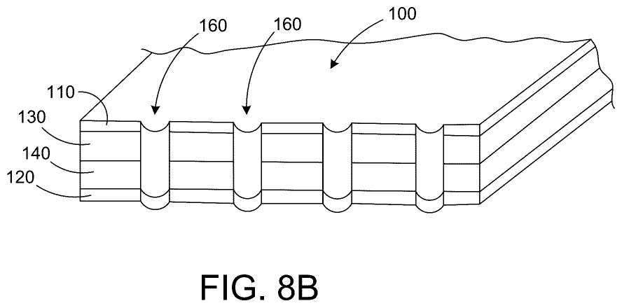

The top and bottom layers 110 and 120 of pad 100 are woven microfiber layers which give the pad body 100 and dimensional integrity. They are ultrasonically adhered to two inner non-woven micro fleece layers 130 and 140 respectively, which in turn are ultrasonically adhered to each other. (See FIGS. 7, 8A, 8B) The pads 100 shown are about 6″ by 6.″ Utility pads 100 can be relatively thin, and the thicknesses discussed above for the first preferred embodiment pad 10, including the approximate thicknesses of its layers 110, 120, 130 and 140, are applicable for pad 100.

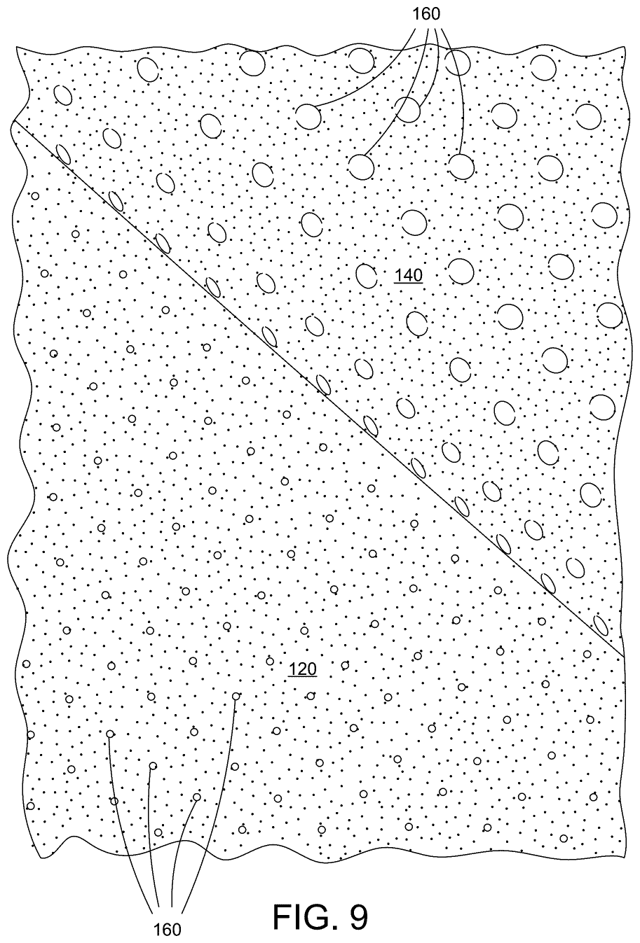

The intermediate non-woven fleece layers 130 and 140 have sandwiched between them and to some extent impregnated in them, 4 grams per square inch of finely divided crystalline particles of super absorbent polymer 20. SAP particles 20 are evenly distributed on application between the two-non-woven fleece layers 130 and 140. Super absorbent particles 20 remain substantially evenly distributed during the life of utility pad 100, in part because pad 100 is dimpled from top layer 110, (FIG. 7) which produces dimples 160 which extend through the two intermediate layers of the non-woven fleece 130 and 140, and at least somewhat into the normally hidden surface of bottom layer 120, as shown in FIGS. 8B and 9. Dimples 160 are distributed at about 14-15 dimples per sq inch of pad 100. Dimples 160 have the added unexpected advantage of increasing the absorbency of the pad layers 110-140, and also help hold the layers lightly together as an adjunct to the ultrasonic treatment. The fact that fleece layers 130 and 140 are lightly adhered is also a factor in holding the SAP particles 20 in their place.

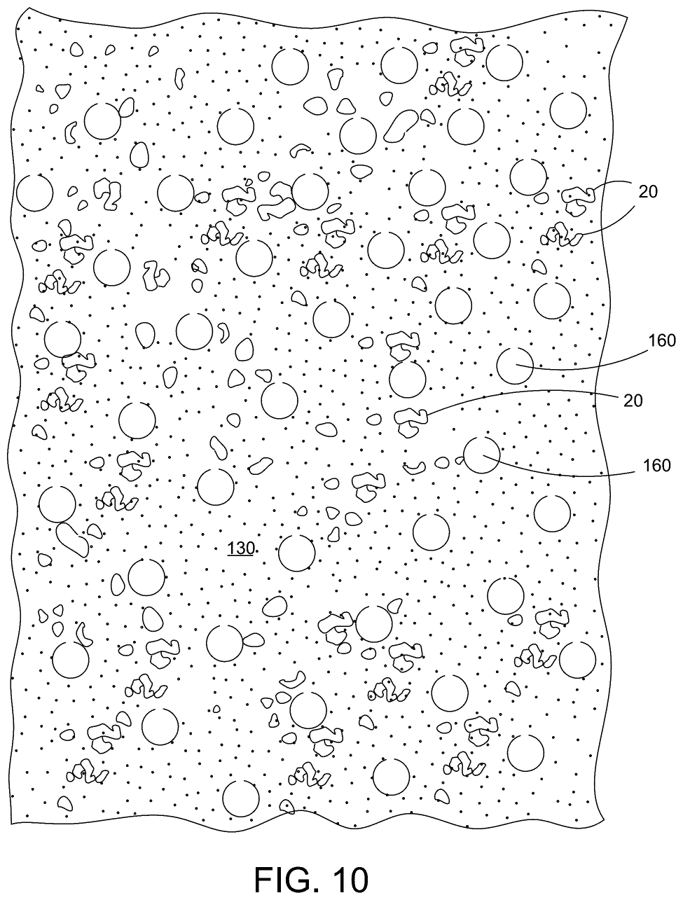

Finely divided crystals of super absorbent polymer 20 are preferably used since that increases their effective surface area for reacting with and absorbing water. As above, 0.1-0.3 mm is a good particle size range, with 0.2 mm preferred. The SAP particles are sprayed in a stream of hot air blown into the fleece layers 130 and 140. FIG. 10 shows a greatly magnified view of fleece layer 130 or 140 depicting dimples 160 projecting through it and with SAP particles 20 embedded in it.

The two intermediate layers 130 and 140 of water absorbent non-woven fleece are lightly adhered throughout by use ultrasound adherence, though other less preferred means such as an evenly distributed light adhesive spray on the inner face of one or both of the two layers. The ultrasonically adhered fleece layers cooperate with said dimples 160 to restrict the mobility of SAP particles 20 between the two layers 130 and 140 that particles 20 remain substantially evenly distributed between the two facing inner layers, and the two facing layers remain sufficiently evenly adhered throughout that they remain an integrated two layer fleece.

In this second preferred embodiment, the SAP particles 20 are trapped between said two intermediate non-woven fleece layers (130 and 140) by forming border 170 from a ribbon 170 wrapped around fleece layers (130 and 140) and hence attached to the edge portions of exterior surfaces of top and bottom layers 110 and 120 to seal SAP particles 20 between intermediate non-woven fleece layers (130 and 140).

As above, it is important that layers 110 and 120 be water permeable so that waste liquids in a waste container or spilled on a floor can penetrate layers 110 and 120 into the fleece layer 130 and 140 and be absorbed by the SAP particles 20. To that end, hydrophilic fibers should be used to fabricate layers 110 and 120. Hydrophilic fibers can be natural and synthetic. Examples of natural hydrophilic fibers include cotton, linen, and wool. Examples of synthetic hydrophilic fibers include polyester, nylon and rayon. The preferred embodiment fiber is a blend of viscose and polyester, most preferably at 30% viscose and 70% polyester.

### Test Results for Second Preferred Embodiment

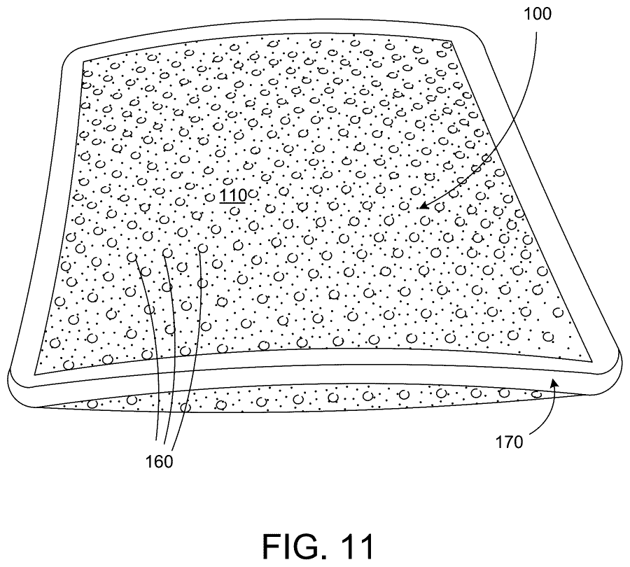

A 6 by 6-inch utility pad was placed in a pool of 34 oz of water. In 4 minutes, the pad absorbed about 12 fluid oz of water. That is an absorption rate of about 0.1 oz/square inch/minute. By 8 minutes, another 6 ounces was absorbed, and the 6 by 6-inch utility pad 100 was saturated at 18 fluid ounces. Thus a 6 by 6-inch utility pad 100 would hold 0.5 ounces per square inch. FIG. 11 shows pad 100 in its swollen condition at the close of this test.

1. A super absorbent pad comprising:
a relatively thin utility pad about 0.1 to 0.25 inches thick impregnated with finely divided super absorbent polymer (SAP) particles which rapidly absorb 30-300 times its weight in water and water based products;
said pad comprising four layers:
a thin water permeable fabric top layer,
a thin water permeable fabric bottom layer, and
two thin layers of non-woven fleece sandwiched between said top and bottom water permeable fabric layers;
said intermediate fleece layers holding between them finely divided particles of super absorbent polymer distributed through the space between said fleece layers; the edges of at least said top and bottom fabric layers being secured together such that said SAP particles cannot escape from between said fleece layers.

2. The super absorbent pad of claim 1 in which each of said intermediate fleece layers have a napped surface of short nap fibers projecting away from their surfaces; said napped surfaces of said two fleeces facing each other such that said short fleece fibers project toward each other between said two fleece layers, holding between their facing napped surfaces and tending to restrict the movement of and maintain the distribution of said finely divided particles of super absorbent polymer.

3. The super absorbent pad of claim 2 in which said two fleece layers are lightly adhered together face to face to restrict movement of SAP particles in their dispersed positions between said top and bottom fleece layers.

4. The super absorbent pad of claim 2 in which said two fleece layers are lightly adhered together ultrasonically face to face to restrict movement of SAP particles in their dispersed positions between said top and bottom fleece layers.

5. The super absorbent pad of claim 2 in which said finely divided particles of super absorbent polymer are about 0.1 mm to 0.3 mm, and about 1-4 grams of SAP particles per square inch of fleece is evenly distributed between said fleece layers.

6. The super absorbent pad of claim 2 in which about 1.7 grams per square inch are distributed evenly between said fleece layers.

7. The super absorbent pad of claim 1 in which said top and bottom fabric layers are secured together near their perimeters to define a border at the perimeter of said utility pad.

8. The super absorbent pad of claim 6 in which said top and bottom fabric layers are secured together by a sewn seam that will leave the edges of said top and bottom fabric layers exposed and free to wick water and water based liquids through said exposed edges past said sewn seam, and into said fleece layers.

9. The super absorbent pad of claim 6 in which said intermediate fleece layers are just smaller enough at their perimeters that no portion of their fleece perimeters are caught beyond said sewn seam. to minimize the possibility that any of said SAP particles will be trapped within sad border outside said seam and become and cause an inconvenience in storing and handling said utility pads.

10. The super absorbent pad of claim 8 in which said finely divided particles of super absorbent polymer are about 0.1 mm to 0.3 mm, and about 1-4 grams of SAP particles per square inch of fleece is evenly distributed between said fleece layers.

11. The super absorbent pad of claim 1 in which said top and bottom fabric layers are each a thin sheet of woven microfiber.

12. The super absorbent pad of claim 1 which has an overall thickness of about 0.16 inches; each of said top and bottom fabric layers is about 0.5 mm thick; and each of said fleece layers has a thickness of about 1.5 mm.

13. The super absorbent pad of claim 1 in which the edges of at least said top and bottom fabric layers are secured together ultrasonically such that said SAP particles cannot escape from between said fleece layers.

14. The super absorbent pad of claim 13 in which said two fleece layers are lightly adhered together ultrasonically face to face to restrict movement of SAP particles in their dispersed positions between said top and bottom fleece layers.

15. The super absorbent pad of claim 14 in which said finely divided particles of super absorbent polymer are about 0.1 mm to 0.3 mm, and about 1-4 grams of SAP particles per square inch of fleece is evenly distributed between said fleece layers.

16. The super absorbent pad of claim 1 in which there are 14-15 dimples per square inch in said top and bottom fabric layers of said pad to restrict the movement of said super absorbent particles located between said layers.

17. The super absorbent pad of claim 1 in which a ribbon is folded over and secured to the edges of said top and bottom fabric layers to seal SAP particles between said layers.

18. The super absorbent pad of claim 1 in which said SAP particles are located between said two fleece layers and said two fleece layers are lightly adhered to restrict movement of SAP particles in their dispersed positions below said top and bottom fleece layers.

19. The use of a super absorbent utility pad comprising: a relatively thin utility pad impregnated with finely divided super absorbent polymer (SAP) particles which rapidly absorb water and water based products such as alcoholic and non-alcoholic beverages, to absorb and control water and water based liquids in waste receptacles or in floods or spills.

20. A method for producing super absorbent utility pads as claimed in claim 1 comprising before bringing said facing fleece layers together, said napped side of one or both fleece layers are sprayed with SAP particles in a stream of hot air blown evenly into the passing fleece such that about 1 to about 4 grams of SAP particles per square inch of fleece is deposited in even distribution on its napped side, which is then pressed and cut into appropriate sized intermediate layers, and assembling said intermediate fleece layers between top and bottom thin water permeable fabric layers.
